(19) United States
(12) Patent Application Publication
(10) Pub. No.: US 2025/0046851 A1
(43) Pub. Date: Feb. 6, 2025

(54) ELECTRICITY STORAGE DEVICE MANUFACTURING APPARATUS

(71) Applicant: Prime Planet Energy & Solutions, Inc., Tokyo (JP)

(72) Inventor: Jo MATSUDA, Kasai-shi (JP)

(21) Appl. No.: 18/780,482

(22) Filed: Jul. 23, 2024

(30) Foreign Application Priority Data
Aug. 1, 2023 (JP) 2023-125209

(51) Int. Cl. H01M 10/04; B23K 26/38; B23K 101/38

(52) U.S. Cl. CPC H01M 10/0409; B23K 26/38; H01M 10/0468; B23K 2101/38

(57) ABSTRACT

An electricity storage device manufacturing apparatus includes a winding shaft, a first conveyance device, a second conveyance device, a first laser tab cut processing device, a second laser tab cut processing device, a winding device, and a control device. The control device is configured to cause execution of a first process in which a tab pitch of a positive electrode sheet that is wound around the winding shaft is acquired, a second process in which a tab pitch of a negative electrode sheet that is wound around the winding shaft is acquired, a third process in which intervals between tabs are adjusted based on the tab pitch of the positive electrode sheet acquired by the first process, and a fourth process in which intervals between tabs are adjusted based on the tab pitch of the negative electrode sheet acquired by the second process.

### CROSS REFERENCE TO RELATED APPLICATIONS

The present application claims the priority based on Japanese Patent Application No. 2023-125209 filed on Aug. 1, 2023, the entire contents of which are incorporated in the present specification by reference.

### BACKGROUND

In Japanese Patent No. 5572676, a winding device that winds a band-like sheet on which stacked portions are formed intermittently in a longitudinal direction of the sheet is disclosed. The winding device includes a winding core, a first pressing device, a detection device, a position adjustment device, and a second pressing device. The winding core is provided so as to be rotatable. The first pressing device is provided so as to rotate integrally with the winding core while pressing the sheet wound around the winding core. The detection device detects positions of end portions of the stacked portions on the sheet that is wound around the winding core in the longitudinal direction of the sheet. The position adjustment device is configured to move at least in a sheet winding direction while gripping the sheet that is wound around the winding core. The position adjustment device aligns the positions of the end portions of the stacked portions on the sheet in the longitudinal direction at respective reference positions set in advance, based on a detection result of the detection device. The second pressing device presses the sheet in an aligned state. According to the winding device described above, the positions of the stacked portions can be highly accurately aligned.

### SUMMARY

The inventor of the present disclosure desires to increase accuracy of positions of electrode tabs of an electricity storage device.

An electricity storage device manufacturing apparatus disclosed herein includes a winding shaft, a first conveyance device, a first laser tab cut processing device, a second conveyance device, a second laser tab cut processing device, a winding device, and a control device. The first conveyance device conveys a band-like positive electrode sheet to the winding shaft. The first laser tab cut processing device forms tabs at intervals determined in advance on the positive electrode sheet that is conveyed by the first conveyance device. The second conveyance device conveys a band-like negative electrode sheet to the winding shaft. The second laser tab cut processing device forms tabs at intervals determined in advance on the negative electrode sheet that is conveyed by the second conveyance device. The winding device rotates the winding shift and winds the positive electrode sheet on which the tabs are formed by the first laser tab cut processing device and the negative electrode sheet on which the tabs are formed by the second laser tab cut processing device. The positive electrode sheet includes a band-like positive electrode current collecting foil and a positive electrode active material layer formed in an area excluding an unformed area set in a first edge portion in a width direction in the band-like positive electrode current collecting foil. The negative electrode sheet includes a band-like negative electrode current collecting foil and a negative electrode active material layer formed in an area excluding an unformed area set in a first edge portion in a width direction in the band-like negative electrode current collecting foil. The control device is configured to causes execution of a first process in which a tab pitch of the positive electrode sheet that is wound around the winding shaft with respect to a rotation angle of the winding shaft is acquired, a second process in which a tab pitch of the negative electrode sheet that is wound around the winding shaft with respect to the rotation angle of the winding shaft is acquired, a third process in which the first laser tab cut processing device adjusts the intervals between the tabs that are formed on the positive electrode sheet, based on the tab pitch of the positive electrode sheet that is wound around the winding shaft with respect to the rotation angle of the winding shaft acquired by the first process, and a fourth process in which the second laser tab cut processing device adjusts the intervals between the tabs that are formed on the negative electrode sheet, based on the tab pitch of the negative electrode sheet that is wound around the winding shaft with respect to the rotation angle of the winding shaft acquired by the second process.

According to the electricity storage device manufacturing apparatus described above, the accuracy of the positions of the tabs is increased.

### BRIEF DESCRIPTION OF THE DRAWINGS

FIG. 1 is a cross-sectional view of an electricity storage device 1.

FIG. 2 is a schematic view of a wound electrode body 20.

FIG. 3 is a schematic view illustrating an electricity storage device manufacturing apparatus 100.

FIG. 4 is a schematic view of a winding shaft 110.

FIG. 5 is a schematic view of a positive electrode sheet 21 in which tabs 21d are formed.

FIG. 6 is a block diagram illustrating a process that is executed by a control device 180.

FIG. 7 is a schematic view illustrating a first tab detection device 201.

FIG. 8 is a block diagram illustrating a process that is executed by the control device 180 according to another embodiment.

FIG. 9 is a schematic view illustrating image inspection devices 204 and 205.

FIG. 10 is a schematic view illustrating an image inspection device 206.

FIG. 11 is a schematic view illustrating a wound body 20a after being temporarily pressed.

FIG. 12 is a block diagram illustrating a process that is executed by the control device 180 according to another embodiment.

FIG. 13 is a schematic view illustrating a thickness inspection device 207.

FIG. 14 is a block diagram illustrating a process that is executed by the control device 180 according to another embodiment.

FIG. 15 is a block diagram illustrating a process that is executed by the control device 180 according to another embodiment.

FIG. 16 is a block diagram illustrating a process that is executed by the control device 180 according to another embodiment.

FIG. 17 is a block diagram illustrating a process that is executed by the control device 180 according to another embodiment.

### DETAILED DESCRIPTION

Embodiments of a technology disclosed herein will be described below with reference to the accompanying drawings. As a matter of course, the embodiments described herein are not intended to be particularly limiting the present disclosure. The accompanying drawings are schematic and do not necessarily reflect actual members or portions. Members/portions that have the same effect will be denoted by the same sign as appropriate, and the overlapping description will be omitted as appropriate.

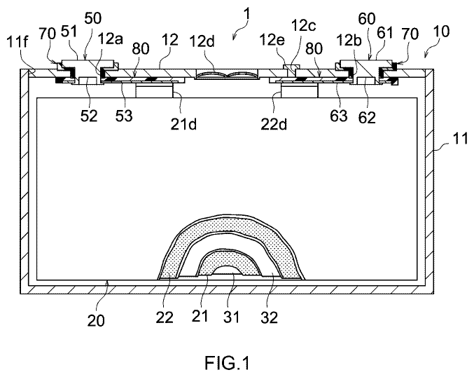

FIG. 1 is a cross-sectional view of an electricity storage device 1. In FIG. 1, the electricity storage device 1 is schematically illustrated such that a front-side broad width surface of a case 10 is virtually removed and inside of the case 10 is visible. The electricity storage device 1 is a form of an electricity storage device that is manufactured by an electricity storage device manufacturing apparatus 100 disclosed herein, and a wound electrode body 20 is housed inside the case 10. An electricity storage device that is manufactured by an electricity storage device manufacturing apparatus disclosed herein is not limited to the form illustrated in FIG. 1.

### Electricity Storage Device 1

The electricity storage device 1 is a laterally long rectangular electricity storage device. As illustrated in FIG. 1, the electricity storage device 1 includes the case 10, a wound electrode body 20, a positive electrode terminal 50, and a negative electrode terminal 60. The case 10 includes a case body 11 and a lid 12.

### <Case Body 11>

The case body 11 is a bottomed rectangular case and has a laterally long rectangular accommodation space. The case body 11 mainly accommodates the wound electrode body 20. The case body 11 includes an approximately rectangular bottom surface, a pair of broad width surfaces extending along long sides of the bottom surface and opposed to each other, and a pair of narrow width surfaces extending along short sides of the bottom surface and opposed to each other. An opening 11f that accommodates the wound electrode body 20 is formed at a surface opposed to the bottom surface. The lid 12 is attached to the opening 11f.

### <Lid 12>

The lid 12 is mounted to the opening 11f of the case 10. The lid 12 is formed of an approximately rectangular plate material that can be mounted to the opening 11f of the case body 11. An attachment hole 12a to which the positive electrode terminal 50 is attached is formed on one side of the lid 12 in a longitudinal direction, and an attachment hole 12b to which the negative electrode terminal 60 is attached is formed on the other side.

A liquid injection hole 12c and a gas discharge valve 12d are provided in the lid 12. The liquid injection hole 12c is a through hole provided for injecting a nonaqueous electrolyte solution into the case 10 after being sealed. The liquid injection hole 12c is sealed by mounting a sealing member 12e thereto after injecting the nonaqueous electrolyte solution. The gas discharge valve 12d is a thin portion that is designed to break (open) and discharge gas out of the case 10 when a large amount of gas is generated in the case 10.

A nonaqueous electrolyte solution used for a known electricity storage device can be used for the nonaqueous electrolyte solution, but not particularly limited thereto. For example, the nonaqueous electrolyte solution can be prepared by dissolving a support salt in a nonaqueous solvent.

### <Positive Electrode Terminal 50 and Negative Electrode Terminal 60>

The positive electrode terminal 50 and the negative electrode terminal 60 are attached to the lid 12. The wound electrode body 20 is accommodated in the case body 11 in a state of being attached to the positive electrode terminal 50 and the negative electrode terminal 60. The positive electrode terminal 50 includes an external coupling portion 51 and a shaft portion 52. The negative electrode terminal 60 includes an external coupling portion 61 and a shaft portion 62. The positive electrode terminal 50 and the negative electrode terminal 60 are coupled to the lid 12 via an insulator 70. Each of the positive electrode terminal 50 and the negative electrode terminal 60 is coupled to a corresponding one of internal terminals 53 and 63 provided in the case 10.

The external coupling portions 51 and 61 are arranged on an outer side of the lid 12 with the insulators 70. Each of the internal terminals 53 and 63 is attached to an inner side of the lid 12 via a gasket 80. The insulators 70 and the gaskets 80 are insulation members. The insulators 70 and the gaskets 80 are formed of resin having desired rigidity. Each of the internal terminals 53 and 63 includes an attachment hole and couples a corresponding one of the positive electrode terminal 50 and the negative electrode terminal 60 to a corresponding one of the shaft portions 52 and 62. Each of lower ends of the shaft portions 52 and 62 is caulked around a corresponding one of attachment holes of the internal terminals 53 and 63.

The positive electrode terminal 50 and the negative electrode terminal 60 are attached to the lid 12 so as to be electrically insulated from the lid 12 via the insulators 70 and the gaskets 80 with airtightness ensured. The wound electrode body 20 is coupled to the positive electrode terminal 50 and the negative electrode terminals 60 via the internal terminal 53 and 63. The wound electrode body 20 is accommodated in the case body 11 so as to be attached to the lid 12 in the manner described above. Multiple wound electrode bodies 20 may be attached to one lid 12, and multiple wound electrode bodies 20 may be accommodated in one case 10.

### <Wound Electrode Body 20>

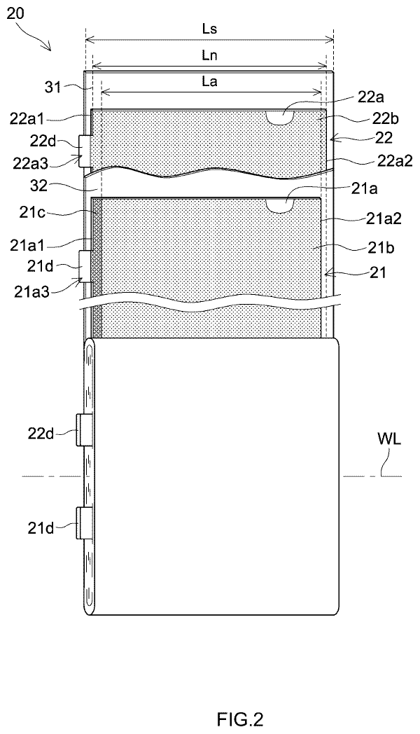

FIG. 2 is a schematic view of the wound electrode body 20. In FIG. 2, the wound electrode body 20 is illustrated with one end developed. As illustrated in FIG. 2, for example, the wound electrode body 20 is configured such that a positive electrode sheet 21, a first separator 31, a negative electrode sheet 22, and a second separator 32 each of which has a long band-like shape are successively stacked with longitudinal directions thereof aligned with each other and are wound around a winding axis WL set in a width direction. The positive electrode sheet 21 and the negative electrode sheet 22 will be also referred to as a positive electrode plate and a negative electrode plate, respectively.

The positive electrode sheet 21 includes a band-like positive electrode current collecting foil 21a, a positive electrode active material layer 21b, and a tab 21d. The positive electrode current collecting foil 21a is a base material of the positive electrode sheet 21. The positive electrode current collecting foil 21a is formed of a predetermined metal foil (for example, aluminum foil). In the band-like positive electrode current collecting foil 21a, a first edge portion 21al is set at one end (a left side in FIG. 2) in the width direction, and a second edge portion 21a2 is set at the other end (a right side in FIG. 2). An unformed area 21a3 is set in the first edge portion 21al of the band-like positive electrode current collecting foil 21a in the width direction. The positive electrode active material layer 21b is formed in an area excluding the unformed area 21a3. The positive electrode active material layer 21b is formed on the positive electrode current collecting foil 21a so as to have a certain width from an end portion on one side in the width direction. A protective layer 21c including insulative ceramic particles may be formed in a portion of the positive electrode current collecting foil 21a excluding a portion where the positive electrode active material layer 21b is formed. On the positive electrode current collecting foil 21a, the tab 21d is formed on a side on which the protective layer 21c is formed so as to protrude in the width direction. The tab 21d is a portion partially protruding with a predetermined width on the side on which the protective layer 21c is formed. The positive electrode current collecting foil 21a is exposed at the tab 21d. Note that the protective layer 21c is not an essential component of the positive electrode sheet.

The positive electrode active material layer 21b is a layer including a positive electrode active material. For example, in a lithium-ion secondary battery, like a lithium transition metal composite material, the positive electrode active material can discharge lithium ions during charging and absorb lithium ions during discharging. For the positive electrode active material, various other materials than the lithium transition metal composite material have been proposed in general, and is not particularly limited.

The negative electrode sheet 22 includes a band-like negative electrode current collecting foil 22a, a negative electrode active material layer 22b, and a tab 22d. The negative electrode current collecting foil 22a is a base material of the negative electrode sheet 22. The negative electrode current collecting foil 22a is formed of a predetermined metal foil (for example, copper foil). In the band-like negative electrode current collecting foil 22a, a first edge portion 22al is set on one end (the left side in FIG. 2) in the width direction, and a second edge portion 22a2 is set at the other end (the right side in FIG. 2). An unformed area 22a3 is set in the first edge portion 22al of the band-like negative electrode current collecting foil 22a in the width direction. The negative electrode active material layer 22b is formed in an area excluding the unformed area 22a3. The negative electrode active material layer 22b is formed on the negative electrode current collecting foil 22a so as to have a certain width from the end portion on one side in the width direction. The tab 22d is formed on the negative electrode current collecting foil 22a so as to protrude on one side in the width direction. The tab 22d is a portion partially protruding outward with a predetermined width on the side on which the unformed area 22a3 is provided. The negative electrode current collecting foil 22a is exposed at the tab 22d.

In this embodiment, in the positive electrode sheet 21 and the negative electrode sheet 22, the unformed areas 21a3 and 22a3 are set in the first edge portions 21al and 22al on the same side, but not limited thereto. The unformed areas 21a3 and 22a3 may be set in the second edge portions 21a2 and 22a2 of the positive electrode sheet 21 and the negative electrode sheet 22. One of the unformed areas 21a3 and 22a3 may be set in a corresponding one of the first edge portions 21al and 22al, and the other one of the unformed areas 21a3 and 22a3 may be set in a corresponding one of the second edge portions 21a2 and 22a2. In this case, the tabs 21d and 22d can protrude from the positive electrode sheet 21 and the negative electrode sheet 22, respectively, in different directions (for example, in opposite directions).

The negative electrode active material layer 22b is a layer including a negative electrode active material. There is no particular limitation on the negative electrode active material, as long as the negative electrode active material can reversibly absorb and discharge a charge carrier in the relation with the positive electrode active material described above. Examples of the negative electrode active material include a carbon material, a silicon-based material, or the like.

As illustrated in FIG. 2, the negative electrode active material layer 22b of the negative electrode sheet 22 may be configured to cover the positive electrode active material layer 21b of the positive electrode sheet 21 with the separators 31 and 32 interposed therebetween. Furthermore, the separators 31 and 32 may be configured to cover the positive electrode active material layer 21b of the positive electrode sheet 21 and the negative electrode active material layer 22b of the negative electrode sheet 22. Although not illustrated, lengths of the positive electrode sheet 21, the negative electrode sheet 22, and the separators 31 and 32 may be set to satisfy the separators 31 and 32>the negative electrode sheet 22>the positive electrode sheet 21. A width La of the positive electrode active material layer 21b, a width Ln of the negative electrode active material layer 22b, and a width Ls of the separators 31 and 32 may be set to satisfy Ls>Ln>La. In a portion where the positive electrode sheet 21 and the negative electrode sheet 22 overlap, a portion where the positive electrode active material layer 21b is formed is covered with the negative electrode active material layer 22b. In a portion where the negative electrode active material layer 22b overlaps the positive electrode sheet 21, the protective layer 21c is formed in a portion where the positive electrode active material layer 21b is not opposed thereto.

As illustrated in FIG. 2, the tab 21d of the positive electrode sheet 21 sticks out from the separators 31 and 32 on one side in the width direction. Multiple tabs 21d are provided on the positive electrode sheet 21 at a predetermined pitch in the longitudinal direction. The tab 22d of the negative electrode sheet 22 sticks out from the separators 31 and 32 on the same side where the tab 21d of the positive electrode sheet 21 sticks out. Multiple tabs 22d are provided on the negative electrode sheet 22 at a predetermined pitch in the longitudinal direction. The tabs 21d of the positive electrode sheet 21 and the tabs 22d of the negative electrode sheet 22 are provided at pitches set in advance such that, after performing winding to form the wound electrode body 20, the tabs 21d are located substantially at the same position and the tabs 22d are located substantially at the same position.

As illustrated in FIG. 1 and FIG. 2, the wound electrode body 20 is put into the case body 11 from the opening 11f to which the lid 12 is mounted so as to be accommodated in the case body 11. Therefore, the wound electrode body 20 has a flat shape in accordance with a shape of the opening 11f. In forming the wound electrode body 20, the wound electrode body 20 may be formed by winding the sheets around a shaft having a flat shape when being wound. Alternatively, in forming the wound electrode body 20, the wound electrode body 20 may be formed by winding the sheets around a shaft having a cylindrical shape and then pressing an obtained wound body into a flat shape. The wound electrode body 20 and the case body 11 are electrically insulated from each other by a resin insulating sheet (not illustrated) arranged between the wound electrode body 20 and the case body 11.

Incidentally, as a method for manufacturing a wound electrode body used for an electricity storage device, a method in which a positive electrode sheet and a negative electrode sheet with tabs formed thereon in advance are prepared and then are wound can be used. For example, in preparing the positive electrode sheet and the negative electrode sheet, the tabs are formed on the positive electrode sheet and the negative electrode sheet in accordance with processing conditions set in advance. After preparing the positive electrode sheet and the negative electrode sheet with the tabs formed thereon, the positive electrode sheet and the negative electrode sheet are wound around a winding shaft with a separator interposed therebetween. In contrast, the inventor of the present disclosure devised to cut the positive electrode sheet and the negative electrode sheet by laser and wind the positive electrode sheet and the negative electrode sheet while forming tabs. According to a finding of the inventor of the present disclosure, in winding the positive electrode sheet and the negative electrode sheet, the tabs are not necessarily superimposed in certain positions, and positions of the tabs can be shifted within an allowable range set in advance. When a thickness largely varies in each of surfaces of the positive electrode sheet and the negative electrode sheet or the like, shifts of the tabs can occur beyond the allowable range set in advance. The tabs are shifted due to processing (pressing or the like) of an obtained wound body after winding in some times. In particular, when a size of the wound electrode body is increased and the number of times of windings is increased, the tabs are likely to be largely shifted.

### Electricity Storage Device Manufacturing Apparatus 100

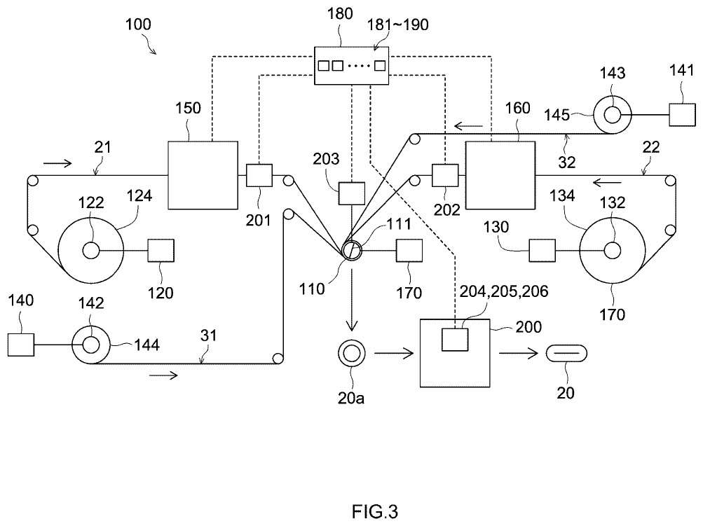

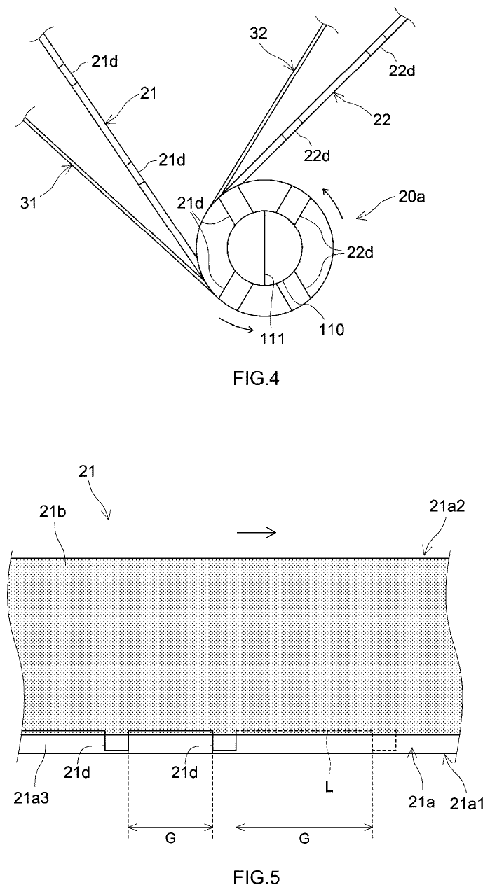

The electricity storage device manufacturing apparatus 100 is an apparatus that manufactures the electricity storage device 1. FIG. 3 is a schematic view illustrating the electricity storage device manufacturing apparatus 100. FIG. 4 is a schematic view of a winding shaft 110. As illustrated in FIG. 3, the electricity storage device manufacturing apparatus 100 includes the winding shaft 110, a first conveyance device 120, a second conveyance device 130, third conveyance devices 140 and 141, a first laser tab cut processing device 150, a second laser tab cut processing device 160, a winding device 170, and a control device 180. The electricity storage device manufacturing apparatus 100 may include a pressing device 200.

In the electricity storage device manufacturing apparatus 100, the positive electrode sheet 21, the negative electrode sheet 22, and the separators 31 and 32 are conveyed by the first conveyance device 120, the second conveyance device 130, and the third conveyance devices 140 and 141, respectively. During conveying the positive electrode sheet 21, the negative electrode sheet 22, and the separators 31 and 32, the tabs 21d and 22d are formed on the positive electrode sheet 21 and the negative electrode sheet 22 by the first laser tab cut processing device 150 and the second laser tab cut processing device 160, respectively. The positive electrode sheet 21 and the negative electrode sheet 22 on which the tabs 21d and 22d are formed are wound around the winding shaft 110 by the winding device 170, and a wound body 20a is formed. As described above, in the electricity storage device manufacturing apparatus 100, while the tabs 21d and 22d are formed on the positive electrode sheet 21 and the negative electrode sheet 22, the positive electrode sheet 21 and the negative electrode sheet 22 are wound. Each of the devices will be described blow.

### <Winding Shaft 110>

As illustrated in FIG. 4, the winding shaft 110 is a shaft member around which the positive electrode sheet 21, the negative electrode sheet 22, and the separators 31 and 32 are wound. The positive electrode sheet 21 and the negative electrode sheet 22 are wound with the separators 31 and 32 interposed therebetween.

In this embodiment, the winding shaft 110 is an approximately cylindrical shaft member. There is no particular limitation on a shape of the winding shaft 110. The winding shaft 110 may have a perfect circular cross section and may have a flat shape. In this embodiment, a slit 111 is formed in the winding shaft 110. The slit 111 is formed so as to pass on a central axis (winding axis). The winding shaft 110 has a shape that is divided by the slit 111 in a radial direction. Note that a slit may be not necessarily formed in the winding shaft 110.

Note that various additional components may be provided to the winding shaft 110. For example, a component that sucks sheets (in this embodiment, the positive electrode sheet 21, the negative electrode sheet 22, and the separators 31 and 32) that are wound around the winding shaft 110 may be provided to the winding shaft 110. A space may be formed in the winding shaft 110 such that a pressure in the space is a negative pressure with respect to outside. A hole that passes through from the space toward a surface of the winding shaft 110 may be formed in the winding shaft 110. The hole can act as a suction hole through which the sheets that are wound around the winding shaft 110 are sucked. Thus, positions of the sheets are less likely to be shifted during winding of the sheets. Moreover, a groove that serves as a receiving portion during cutting of the sheets that are wound around the winding shaft 110 may be provided in the winding shaft 110. For example, in cutting the sheets after the sheets have been wound around the winding shaft 110, a blade of a cutter may be put down to the groove. Thus, the winding shaft 110 and the blade of the cutter are less likely to be damaged during cutting of the sheets.

The positive electrode sheet 21, the negative electrode sheet 22, and the separators 31 and 32 are attached to the winding shaft 110. The positive electrode sheet 21, the negative electrode sheet 22, and the separators 31 and 32 are attached to the winding shaft 110 such that the separators 31 and 32 are interposed between the positive electrode sheet 21 and the negative electrode sheet 22 to keep the positive electrode sheet 21 and the negative electrode sheet 22 from contacting each other. The positive electrode sheet 21, the negative electrode sheet 22, and the separators 31 and 32 may be fixed to the winding shaft 110 by pinching respective leading ends thereof in the slit 111. The winding shaft 110 is rotatably driven in a circumferential direction by the winding device 170 (see FIG. 3).

### <Winding Device 170>

The winding device 170 rotates the winding shaft 110. The winding device 170 rotates the winding shaft 110, so that the positive electrode sheet 21 and the negative electrode sheet 22 are wound around the winding shaft 110. There is no particular limitation on the winding device 170, as long as the winding device 170 can rotate the winding shaft 110. As the winding device 170, for example, a motor can be used.

The positive electrode sheet 21 and the negative electrode sheet 22 are wound around the winding shaft 110 such that the tabs 21d and 22d are arranged in positions determined in advance with respect to a rotation angle of the winding shaft 110. The positive electrode sheet 21 and the negative electrode sheet 22 are wound around the winding shaft 110 such that the tabs 21d of the positive electrode sheet 21 are superimposed with one another in the radial direction and the tab 22d of the negative electrode sheet 22 are superimposed with one another in the radial direction. In this embodiment, the positions of the tabs 21d of the positive electrode sheet 21 and the tabs 22d of the negative electrode sheet 22 are set so as to be superimposed in different positions in the circumferential direction. In this embodiment, the positive electrode sheet 21 and the negative electrode sheet 22 are wound such that the tabs 21d and the tabs 22d are superimposed at a predetermined angle with respect to a reference line of the winding shaft 110. Note that an arbitrary line extending in the radial direction of the winding shaft 110 can be set as the reference line of the winding shaft 110. In this embodiment, the positive electrode tabs 21d and the negative electrode tabs 22d are superimposed at positions symmetrical with respect to the slit 111. The superimposed positive electrode tabs 21d are arranged in two positions in the circumference direction, and the superimposed negative electrode tabs 22d are arranged in two positions in the circumference direction.

As illustrated in FIG. 3, each of the positive electrode sheet 21, the negative electrode sheet 22, and the separators 31 and 32 is conveyed to the winding shaft 110 by a corresponding one of the first conveyance device 120, the second conveyance device 130, and the third conveyance devices 140 and 141.

### <First Conveyance Device 120, Second Conveyance Device 130, and Third Conveyance Devices 140 and 141>

The first conveyance device 120 conveys the band-like positive electrode sheet 21 to the winding shaft 110. The second conveyance device 130 conveys the band-like negative electrode sheet 22 to the winding shaft 110. The third conveyance devices 140 and 141 convey the band-like separators 31 and 32 to the winding shaft 110.

Each of the positive electrode sheet 21, the negative electrode sheet 22, and the separators 31 and 32 is wound around a corresponding one of unwinding shafts 122, 132, 142, and 143. Each of the first conveyance device 120, the second conveyance device 130, and the third conveyance devices 140 and 141 is coupled to a corresponding one of the unwinding shafts 122, 132, 142, and 143. Each of a positive electrode roll 124, a negative electrode roll 134, and separator rolls 144 and 145 is wound on a corresponding one of the unwinding shafts 122, 132, 142, and 143. The positive electrode roll 124 is a roll around which the band-like positive electrode sheet 21 before the tabs 21d are formed is wound. The negative electrode roll 134 is a roll around which the band-like negative electrode sheet 22 before the tabs 22d are formed is wound. Each of the separator rolls 144 and 145 is a roll around which a corresponding one of the band-like separators 31 and 32 is wound.

The first conveyance device 120, the second conveyance device 130, and the third conveyance devices 140 and 141 rotatably drive the unwinding shafts 122, 132, 142, and 143, respectively. Thus, each of the positive electrode roll 124, the negative electrode roll 134, and the separator rolls 144 and 145 is unwound from a corresponding one of the unwinding shafts 122, 132, 142, and 143. There is no particular limitation on the first conveyance device 120, the second conveyance device 130, and the third conveyance devices 140 and 141, as long as the first conveyance device 120, the second conveyance device 130, and the third conveyance devices 140 and 141 can rotate the unwinding shafts 122, 132, 142, and 143. As the first conveyance device 120, the second conveyance device 130, and the third conveyance devices 140 and 141, for example, motors or the like can be used.

Conveyance speed can be controlled in accordance with conveyance conditions set to the control device 180. Each of the positive electrode sheet 21, the negative electrode sheet 22, and the separators 31 and 32 can be conveyed to the winding shaft 110 at approximately constant speed by a corresponding one of the first conveyance device 120, the second conveyance device 130, and the third conveyance devices 140 and 141. Each of the positive electrode sheet 21, the negative electrode sheet 22, and the separators 31 and 32 can be conveyed on a conveyance path set in advance. The conveyance path may be set, for example, by a nip roller, an accumulator, a tension roller, a guide roller, or the like. The first laser tab cut processing device 150 is provided on the conveyance path of the positive electrode sheet 21. The second laser tab cut processing device 160 is provided on the conveyance path of the negative electrode sheet 22. In this embodiment, when the wound body 20a obtained by winding the positive electrode sheet 21, the negative electrode sheet 22, and the separators 31 and 32 the number of times of windings determined in advance is formed, conveyance of the sheets is stopped. When sheets are newly attached to the winding shaft 110, conveyance of the sheets is started by the first conveyance device 120, the second conveyance device 130, and the third conveyance devices 140 and 141. Tab processing is started on the positive electrode sheet 21 and the negative electrode sheet 22 that are to be conveyed.

### <First Laser Tab Cut Processing Device 150 and Second Laser Tab Cut Processing Device 160>

The first laser tab cut processing device 150 forms the tabs 21d on the positive electrode sheet 21 at intervals determined in advance. The first laser tab cut processing device 150 forms the tabs 21d in the unformed area 21a3 of the positive electrode sheet 21 that is conveyed by the first conveyance device 120. The second laser tab cut processing device 160 forms the tabs 22d on the negative electrode sheet 22 at intervals determined in advance. The second laser tab cut processing device 160 forms the tabs 22d in the unformed area 22a3 of the negative electrode sheet 22 that is conveyed by the second conveyance device 130. In this embodiment, on the positive electrode sheet 21 and the negative electrode sheet 22, the tabs are formed in the first edge portions 21al and 22al on the same side in the width direction. However, formation of the tabs is not limited thereto. The tabs may be formed in the first edge portion on one of the positive electrode sheet 21 and the negative electrode sheet 22 and in the second edge portion on the other one of the positive electrode sheet 21 and the negative electrode sheet 22.

Using the first laser tab cut processing device 150 that forms the tabs 21d on the positive electrode sheet 21 as an example, tab formation will be described below. As for tab formation by the second laser tab cut processing device 160, similar to tab formation by the first laser tab cut processing device 150 can be performed, and therefore, detailed description thereof will be omitted.

The first laser tab cut processing device 150 can include, for example, a chamber, a laser oscillator, and a scanner. The chamber surrounds a space in which the tabs 21d are formed in the positive electrode sheet 21. The positive electrode sheet 21 are irradiated with laser while being conveyed in the chamber, so that the tabs 21d can be formed. The laser oscillator is a device that radiates laser. Wavelength, frequency, output, or the like of laser are set as appropriate. The laser oscillator may be attached to the scanner that controls irradiation angle, position, or the like of laser. A locus of laser with which the positive electrode sheet 21 is irradiated can be determined by controlling radiation of laser by the scanner.

FIG. 5 is a schematic view of the positive electrode sheet 21 on which the tabs 21d are formed. In FIG. 5, a locus L of laser with which the positive electrode sheet 21 is irradiated is indicated by a broken line. As illustrated in FIG. 5, in the positive electrode sheet 21 that is conveyed, the unformed area 21a3 is formed in the first edge portion 21al in the width direction. The unformed area 21a3 is not formed in the second edge portion 21a2 in the width direction, and the second edge portion 21a2 is covered with the positive electrode active material layer 21b. A side of the positive electrode sheet 21 in which the first edge portion 21al with the unformed area 21a3 formed therein is provided is irradiated with the laser. An end portion of the positive electrode sheet 21 on the side on which the first edge portion 21al is provided is cut in accordance with the locus L of the laser.

In an area where each of the tabs 21d is formed, the locus L is set to extend along shape and dimension of the tab 21d. Between the areas where the tabs 21d are provided, the locus L is set to head toward an upstream side of the positive electrode sheet 21 only by a length (an interval G between adjacent ones of the tabs 21d) corresponding to a pitch of the tabs 21d in a length direction of the positive electrode sheet 21. Thus, the tabs 21d that have a shape determined in advance are formed on the positive electrode sheet 21 at a pitch determined in advance.

In this embodiment, between the areas in which the tabs 21d are formed, the locus L is set to pass on the positive electrode active material layer 21b in the length direction. Thus, the tabs 21d are formed on the positive electrode sheet 21 such that a portion of a base end of each of the tabs 21d is covered with the positive electrode active material layer 21b. Note that, in order to reduce waste of the positive electrode active material, the locus L can be set near the unformed area 21a3. However, the locus L is not limited thereto, and may be set to pass only on the unformed area 21a3. By doing so, waste of the positive electrode active material can be reduced. A fragment cut off from the positive electrode sheet 21 by laser can be collected by an unillustrated waste material separation device.

Pitch, dimension, or the like of the tabs 21d are set as appropriate in accordance with a configuration of the wound electrode body 20 (see FIG. 2) as a target. The pitch of the tabs 21d that are formed and the interval G of the tabs 21d are not constant, and the pitch of the tabs 21d is set such that, when the wound body 20a (see FIG. 4) is formed, the tabs 21d of the wound positive electrode sheet 21 are superimposed with one another in the radial direction.

As illustrated in FIG. 3, the positive electrode sheet 21 on which the tabs 21d are formed by the first laser tab cut processing device 150 and the negative electrode sheet 22 on which the tabs 22d are formed by the second laser tab cut processing device 160 are wound around the winding shaft 110 by the winding device 170. When the positive electrode sheet 21, the negative electrode sheet 22, and the separators 31 and 32 are wound around the winding shaft 110 the number of times of winding determined in advance, the winding device 170 is stopped. The positive electrode sheet 21, the negative electrode sheet 22, and the separators 31 and 32 wound around the winding shaft 110 are cut by an unillustrated cutter or the like, the separators 31 and 32 as an outer peripheral surface are fastened by a tape of the like, and thus, the wound body 20a is formed. The wound body 20a is taken out from the winding shaft by an unillustrated taking-out device. The taken-out wound body 20a has an approximately cylindrical shape. The wound body 20a is sent to the pressing device 200.

### <Pressing Device 200>

The pressing device 200 temporarily presses the wound body 20a. As the pressing device 200, a known pressing machine or the like can be used. In the pressing device 200, the wound body 20a is pressed by the pressing device 200 in a direction determined in advance. In the wound body 20a, the tabs 21d provided in two positions in the circumferential direction and the tabs 22d provided in two positions in the circumferential direction are pressed such that the tabs 21d in each of the two positions are superimposed with one another and the tabs 22d in each of the two positions are superimposed with one another after the wound body 20a is pressed. Thus, the flat wound body 20a is formed.

The temporarily pressed wound body 20a is pressed with a higher pressing pressure than a pressing pressure of temporary pressing, and thus, the flat wound electrode body 20 is formed. The formed wound electrode body 20 is accommodated in a case and is sealed, an electrolyte solution is injected therein, and thus, an assembly is prepared. The electricity storage device 1 (see FIG. 1) can be manufactured by performing initial charge processing and aging processing on the assembly by a known method.

### <Control Device 180>

The control device 180 controls processing conditions of the first laser tab cut processing device 150 and the second laser tab cut processing device 160. The control device 180 includes a storage 181, a first acquirer 182, a first calculator 183, a first adjustor 184, a second acquirer 185, a second calculator 186, a second adjustor 187, a third acquirer 188, a third calculator 189, and a third adjustor 190. The control device 180 can be a computer, such as, for example, an electronic control unit (ECU), a microcomputer mounted circuit board, or the like. The computer performs desired functions, for example, in accordance with a program set in advance. Each function of the computer is processed by cooperation of an arithmetic unit (also referred to as a processor, a central processing unit (CPU), or a micro-processing unit (MPU)) of the computer and a storage device (memory, hard disk, or the like) and software.

In the electricity storage device manufacturing apparatus 100, the processing conditions of the first laser tab cut processing device 150 and the second laser tab cut processing device 160 are stored in the storage 181 of the control device 180. The locus L of laser can be controlled in accordance with the stored processing conditions. In the electricity storage device manufacturing apparatus 100, the processing conditions stored in the control device 180 are adjusted based on various parameters measured during and after winding of the wound body 20a.

### First Example

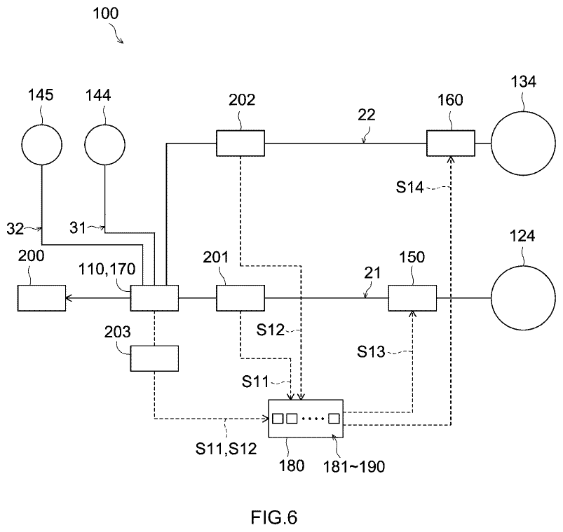

FIG. 6 is a block diagram illustrating processing that is executed by the control device 180. As illustrated in FIG. 6, in the electricity storage device manufacturing apparatus 100, a first tab detection device 201, a second tab detection device 202, and a rotation angle measurement device 203 are provided. The first tab detection device 201 is provided on the conveyance path between the first laser tab cut processing device 150 and the winding shaft 110. The second tab detection device 202 is provided on the conveyance path between the second laser tab cut processing device 160 and the winding shaft 110. The rotation angle measurement device 203 is coupled to the winding shaft 110.

The rotation angle measurement device 203 measures the rotation angle of the winding shaft 110 that is rotatably driven by the winding device 170. In the rotation angle measurement device 203, the number of rotations of the winding shaft 110 may be detected. There is no particular limitation on the rotation angle measurement device 203, as long as the rotation angle measurement device 203 can measure the rotation angle of the winding shaft 110. As the rotation angle measurement device 203, for example, a rotary encoder or the like can be used. The rotation angle of the winding shaft 110 measured by the rotation angle measurement device 203 is transmitted to the control device 180.

The first tab detection device 201 detects passing of the tabs 21d of the positive electrode sheet 21 that is conveyed. The second tab detection device 202 detects passing of the tabs 22d of the negative electrode sheet 22 that is conveyed. The first tab detection device 201 will be described below. The second tab detection device 202 can be configured similarly to the first tab detection device, and therefore, detailed description thereof will be omitted.

There is no particular limitation on the first tab detection device wound electrode body 20, as long as the first tab detection device 201 can detect passing of the tabs 21d of the positive electrode sheet 21 that is conveyed. As the first tab detection device 201, for example, a reflection-type, regression reflection-type, or transmission-type laser sensor can be used. In this embodiment, as the first tab detection device 201, a regression refection-type laser sensor is used.

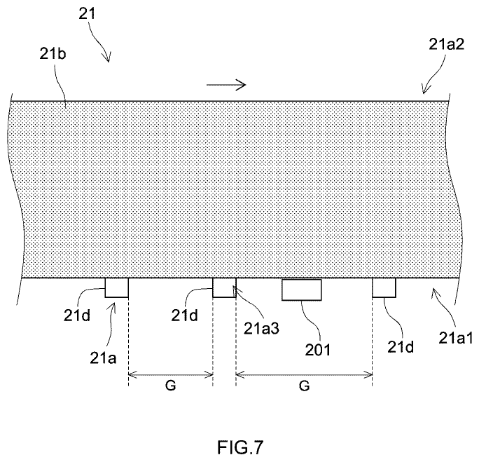

FIG. 7 is a schematic view illustrating the first tab detection device 201. As illustrated in FIG. 7, the first tab detection device 201 radiates laser to a position where the tab 21d passes. In the first tab detection device 201, an optical path is set such that a position determined in advance where the tab 21d passes is irradiated with laser. In FIG. 7, the optical path is set in a depth direction of FIG. 7. During passing of the tab 21d through an irradiation position, laser light is reflected by the tab 21d. The first tab detection device 201 detects passing of the tab 21d by detecting reflection light. When passing of the tab 21d is detected by the first tab detection device 201, detection of the tab 21d is transmitted to the control device 180 (see FIG. 6). The tabs 21d are formed on the positive electrode sheet 21 at a pitch determined in advance. Therefore, each time passing of the tab 21d is detected, detection of the tab 21d is transmitted to the control device 180.

As illustrated in FIG. 6, the control device 180 is configured to cause execution of a first process S11 in which a tab pitch of the positive electrode sheet 21 that is wound around the winding shaft 110 with respect to the rotation angle of the winding shaft 110 is acquired. In this case, “the tab pitch” refers to an interval between adjacent ones of the tabs 21d in the conveyance direction. Herein, the first acquirer 182 of the control device 180 acquires information of passing of the tab 21d from the first tab detection device 201. The first acquirer 182 of the control device 180 acquires the rotation angle of the winding shaft 110 at a time of passing of the tab 21d from the rotation angle measurement device 203. Herein, the first acquirer 182 of the control device 180 acquires the rotation angle of the winding shaft 110 at the time of passing of the tab 21d.

The control device 180 is configured to cause, similar to the first process S11, execution of a second process S12 in which a tab pitch of the negative electrode sheet 22 that is wound around the winding shaft 110 with respect to the rotation angle of the winding shaft 110 is acquired.

In the control device 180, a conveyance condition of the positive electrode sheet 21 and a processing condition of the tabs 21d are programmed such that the tabs 21d of the positive electrode sheet 21 are superimposed at a predetermined angle with respect to the reference line of the winding shaft 110. In the control device 180, a conveyance condition of the negative electrode sheet 22 and a processing condition of the tabs 22d are programmed such that the tabs 22d of the negative electrode sheet 22 are superimposed at a predetermined angle with respect to the reference line of the winding shaft 110.

The control device 180 is configured to cause execution of a third process S13 in which the interval of the tabs 21d is adjusted based on the tab pitch of the positive electrode sheet 21 that is wound around the winding shaft 110 with respect to the rotation angle of the winding shaft 110 acquired by the first process S11. Similarly, the control device 180 is configured to cause execution of a fourth process S14 in which the interval of the tabs 22d is adjusted based on the tab pitch of the negative electrode sheet 22 that is wound around the winding shaft 110 with respect to the rotation angle of the winding shaft 110 acquired by the second process S12. In the wound body 20a that is being wound, the positions of the tabs 21d move in accordance with the rotation angle of the winding shaft 110. The tab pitch varies in accordance with the number of times of windings. The first calculator 183 of the control device 180 calculates a difference between the rotation angle of the winding shaft 110 at the time of passing of the tab 21d acquired during winding and a set value of the rotation angle of the winding shaft 110 at the time of passing of the tab 21d based on the processing condition and conveyance condition that are programmed. When there is a difference between the rotation angle of the winding shaft 110 at the time of passing of the tab 21d acquired during winding and the setting value, the first adjustor 184 adjusts the processing conditions of the tabs 21d and 22d stored in the storage 181. For example, when the tab pitch acquired at a certain rotation angle is larger than the setting value, the first adjustor 184 can adjust the processing conditions such that the tab pitch between the tabs specified from the rotation angle is reduced. When the tab pitch acquired at the certain rotation angle is smaller than the set value, the first adjustor 184 can adjust the processing conditions such that the tab pitch between the tabs specified from the rotation angle is increased.

The control device 180 is configured to cause execution of the first process S11 to the fourth process S14 described above. As described above, in the control device 180, the rotation angle of the winding shaft 110 and the acquired tab pitch are fed back and the processing conditions of the tabs are adjusted. Thus, the interval of the tabs can be easily made close to the set value and the positions of the tabs 21d and 22d can be easily aligned during winding of the wound body 20a. As a result, when the wound electrode body 20 is manufactured, accuracy of the positions of the tabs 21d and 22d is increased.

With increased accuracy of the positions of the tabs 21d and 22d, the tabs 21d and 22d can be easily aligned in a stacking direction also when the electricity storage device 1 is assembled. Thus, the accuracy of the positions of the tabs 21d and 22d in the widths of the tabs 21d and 22d can be increased. As a result, a degree of freedom for design of a component attached to the lid 12 or the like can be increased. For example, dimensions of the internal terminals 53 and 63 can be reduced, resulting in reduction in manufacturing cost. The effect described above is significant in the electricity storage device 1 in which the wound electrode body 20 (see FIG. 2) employing the tabs 21d and the tabs 22d protruding from the same direction.

### Second Example

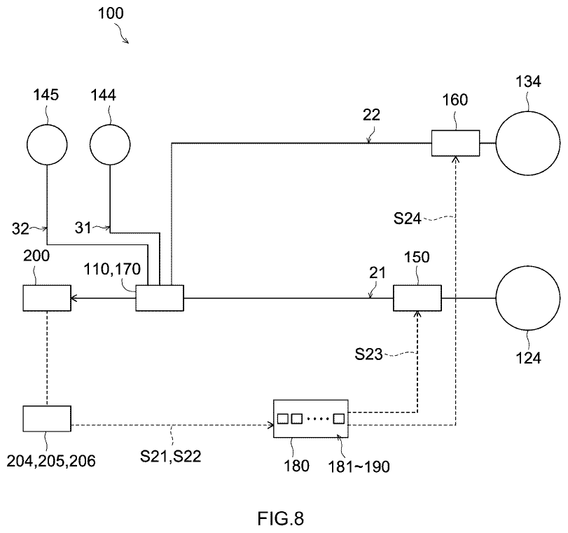

FIG. 8 is a block diagram illustrating a process that is executed by the control device 180 according to another embodiment. As illustrated in FIG. 8, in the electricity storage device manufacturing apparatus 100, image inspection devices 204 to 206 are provided. The image inspection devices 204 to 206 inspect the positions of the tabs 21d and 22d of the wound electrode body 20 pressed by the pressing device 200. There is no particular limitation on the image inspection devices 204 to 206, as long as the devices can inspect the positions of the tabs 21d and 22d. As the image inspection devices 204 to 206, for example, image sensors that can acquire a dimension of a plan view image can be used.

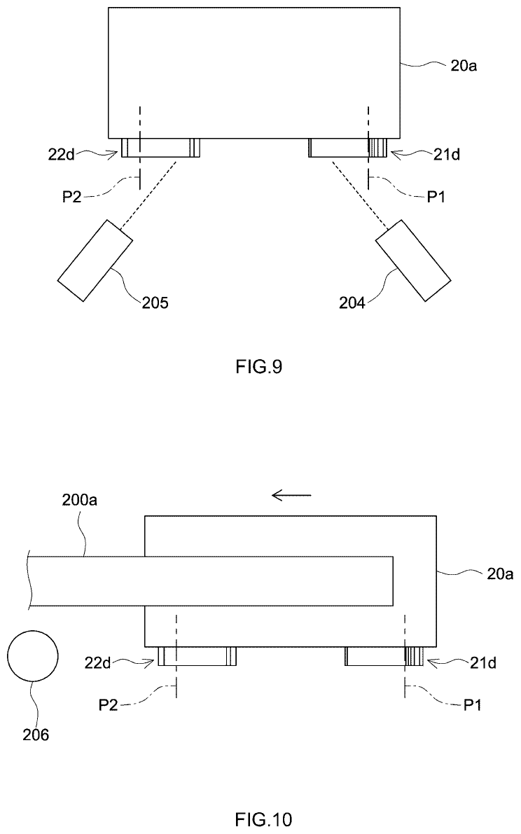

The image inspection device 204 inspects the tab 21d of the positive electrode. The image inspection device 205 inspects the tab 22d of the negative electrode. FIG. 9 is a schematic view illustrating the image inspection devices 204 and 205. In FIG. 9, a positional relation between the image inspection devices 204 and 205 and the tab 21d and the tab 22d when viewed in a direction in which the tabs 21d and 22d are stacked is illustrated. In FIG. 9, illustrating of the pressing device 200 is omitted.

As illustrated in FIG. 9, the image inspection devices 204 and 205 detect the positions of the tabs 21d and 22d of the wound body 20a in a state of being temporarily pressed by the pressing device 200. Each of the image inspection devices 204 and 205 acquires shape data of a corresponding one of the tabs 21d and 22d on a surface where the tabs 21d and 22d protrude. Each of imaging surfaces of the image inspection devices 204 and 205 is directed obliquely with respect to the surface where the tabs 21d and 22d protrude. In the wound body 20a, reference positions P1 and P2 in which outer end portions of the tabs 21d and 22d are to be arranged are set based on the processing conditions of the tabs. Image data acquired by the image inspection devices 204 and 205 is transmitted to the control device 180.

FIG. 10 is a schematic view illustrating the image inspection device 206. In FIG. 10, the positional relation between the image inspection device 206 and the tabs 21d and 22d when viewed in the direction in which the tabs 21d and 22d are stacked is illustrated.

In FIG. 10, an imaging direction of the image inspection device 206 is set in a depth direction of FIG. 10. As illustrated in FIG. 10, the wound body 20a after being temporarily pressed is gripped by a conveyance chuck 200a and is conveyed in a width direction of the tabs 21d and 22d. The image inspection device 206 detects the positions of the tabs 21d and 22d from the stacking direction (press direction of temporary pressing) of the tabs 21d and 22d extending from the wound body 20a. In this embodiment, the image inspection device 206 acquires the position data of the tabs 21d and 22d of the wound body 20a that is conveyed from above. The image data acquired by the image inspection device 206 is transmitted to the control device 180.

As illustrated in FIG. 8, the control device 180 is configured to cause execution of a first process 21S in which the positions of the tabs 21d of the positive electrode sheet 21 of the wound body 20a after being pressed by the pressing device 200 are acquired. The control device 180 is configured to cause, similar to the first process S21, execution of a second process S22 in which the position of the tabs 22d of the negative electrode sheet 22 of the wound body 20a after being pressed by the pressing device 200 are acquired. Herein, the second acquirer 185 of the control device 180 acquires the position data of the tabs 21d and 22d from the image inspection devices 204 to 206.

The control device 180 is configured to cause execution of a third process S23 in which the intervals between the tabs 21d are adjusted based on the positions of the tabs 21d of the positive electrode sheet 21 of the wound body 20a after being pressed by the pressing device 200 acquired by the first process S21. Similarly, the control device 180 is configured to cause execution of a fourth process S24 in which the intervals between the tabs 22d are adjusted based on the positions of the tabs 22d of the negative electrode sheet 22 of the wound body 20a after being pressed by the pressing device 200 acquired by the second process S22. In this embodiment, the second calculator 186 of the control device 180 calculates an amount (length) by which each of the tabs 21d and 22d is shifted from a corresponding one of the reference positions P1 and P2 in the width direction.

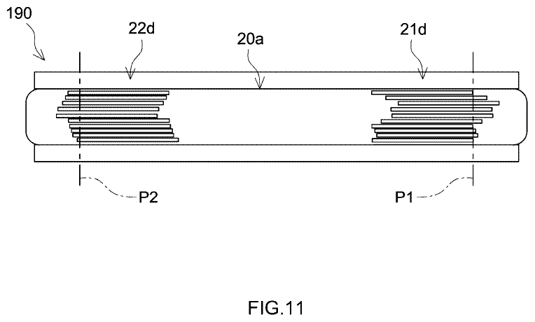

FIG. 11 is a schematic view illustrating the wound body 20a after being temporarily pressed. In FIG. 11, the positions of the tabs 21d and 22d viewed in the direction in which the tabs 21d and 22d protrude are illustrated. As illustrated in FIG. 11, a shift of each of the tabs 21d and 22d of the wound body 20a from a corresponding one of the reference positions P1 and P2 is confirmed from the image data obtained by the image inspection devices 204 and 205 in some cases. The second calculator 186 may be configured to calculate, for each of the tabs 21d and 22d, an amount of a shift from the corresponding one of the reference positions P1 and P2. As illustrated in FIG. 11, the second calculator 186 may be configured to calculate, when the shifts of corresponding ones of the tabs 21d and 22d from a corresponding one of the reference positions P1 and P2 are different from each other, each of the shifts of the tabs 21d and 22d, based on an approximate curve. For example, the second calculator 186 executes a process in which an approximate curve is acquired by connecting the end portions (for example, outer end portions) of corresponding ones of the tabs 21d and 22d. The second calculator 186 may be configured to calculate a shift of each of the tabs 21d and 22d, based on the approximate curve and the corresponding one of the reference positions P1 and P2.

The shifts of the tabs 21d and 22d may be calculated in the stacking direction of the tabs 21d and 22d from the image data acquired by the image inspection device 206 (see FIG. 10). At this time, shifts of the tabs 21d and 22d that can be observed from above can be detected. A largest value among the shifts can be calculated from the image data acquired by the image inspection device 206 for the stacked tabs 21d and 22d.

When the calculated positions of the tabs 21d and 22d are shifted from the reference positions P1 and P2, the second adjustor 187 adjusts processing conditions of the tabs 21d and 22d stored in the storage 181. For example, when the calculated positions of the tabs 21d and 22d are shifted from the reference positions P1 and P2 so that the tabs 21d and 22d proceed the reference positions P1 and P2 in a direction in which the wound body 20a is wound, the processing conditions can be adjusted such that the tab pitch is reduced.

When the calculated positions of the tabs 21d and 22d are shifted from the reference positions P1 and P2 so that the tabs 21d and 22d follow the reference positions P1 and P2 in the direction in which the wound body 20a is wound, the processing conditions can be adjusted such that the tab pitch is increased.

The control device 180 is configured to cause execution of the first process S21 to the fourth process S24. Thus, in the control device 180, the positions of the tabs 21d and 22d of the wound body 20a after being pressed are fed back and the processing conditions of the tabs are adjusted. For example, it is more likely that shifts of the positions of the tabs 21d and 22d that can occur due to pressing of the wound body 20a after winding the sheets around the winding shaft 110 and thus forming the wound body 20a are fed back. Therefore, the processing conditions of the tabs can be adjusted in consideration that the positions of the tabs 21d and 22d are shifted during pressing. As a result, accuracy of the positions of the tabs 21d and 22d in the wound electrode body 20 after being pressed can be increased.

### Third Example

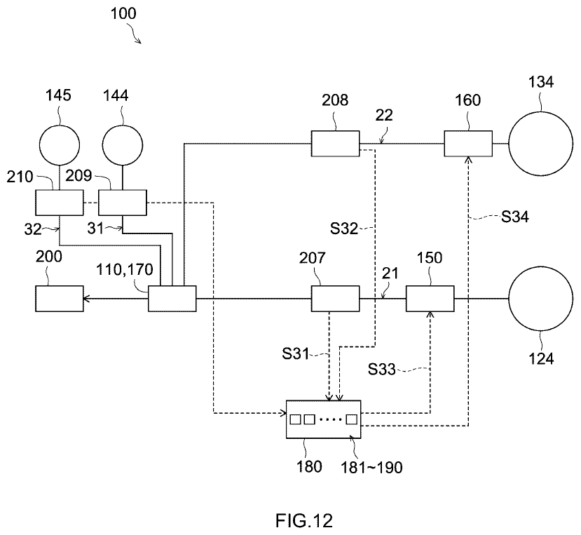

FIG. 12 is a block diagram illustrating a process that is executed by the control device 180 according to another embodiment. As illustrated in FIG. 12, in the electricity storage device manufacturing apparatus 100, thickness inspection devices 207 to 210 are provided.

Each of the thickness inspection devices 207 to 210 measures a thickness of a corresponding one of the positive electrode sheet 21, the negative electrode sheet 22, and the separators 31 and 32 that are conveyed. There is no particular limitation on the thickness inspection devices 207 to 210, as long as the thickness inspection devices 207 to 210 can inspect the thicknesses of the sheets. As the thickness inspection devices 207 to 210, for example, non-contact type laser displacement meters can be used.

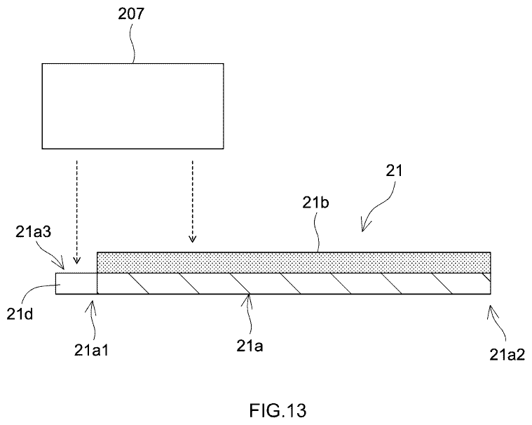

FIG. 13 is a schematic view illustrating the thickness inspection device 207. In FIG. 13, the thickness inspection device 207 and the positive electrode sheet 21 viewed in a direction in which the positive electrode sheet 21 is conveyed are illustrated. As illustrated in FIG. 13, the thickness inspection device 207 is arranged so as to radiate laser approximately vertically to the positive electrode sheet 21. The thickness inspection device 207 radiates laser to surfaces of the unformed area 21a3 of the positive electrode current collecting foil 21a and the positive electrode active material layer 21b formed on the positive electrode current collecting foil 21a. The thickness inspection device 207 detects reflection light reflected from the surfaces of the unformed area 21a3 and the positive electrode active material layer 21b and measures a thickness of the positive electrode active material layer 21b. The thickness inspection device 207 can continuously measure the thickness of the positive electrode active material layer 21b. In this embodiment, the thickness inspection device 207 is provided in a position where the thickness inspection device 207 can measure a thickness of the positive electrode sheet 21 in a position along the unillustrated guide roller. Since the thickness of the positive electrode sheet 21 is measured along the guide roller, shifting in the thickness direction can be suppressed and accuracy of measurement of the thickness of the positive electrode sheet 21 can be increased.

The thickness inspection device 208 (see FIG. 12) that inspects a thickness of the negative electrode active material layer 22b of the negative electrode sheet 22 can be configured similar to the thickness inspection device 207, and therefore, detailed description thereof will be omitted. The thickness inspection devices 209 and 210 (see FIG. 12) measure thicknesses of the separators 31 and 32. The measured thicknesses of the positive electrode active material layer 21b and the negative electrode active material layer 22b are transmitted to the control device 180.

As illustrated in FIG. 12, the control device 180 is configured to cause execution of a first process S31 in which the thickness of the positive electrode sheet 21 that is wound around the winding shaft 110 is acquired. The control device 180 is configured to cause, similar to the first process S31, execution of a second process S32 in which the thickness of the negative electrode sheet 22 that is wound around the winding shaft 110 is acquired. Herein, the third acquirer 188 of the control device 180 acquires data of the thicknesses of the positive electrode sheet 21, the negative electrode sheet 22, and the separators 31 and 32 from the thickness inspection devices 207 to 210.

The control device 180 is configured to cause execution of a third process S33 in which the interval of the tabs 21d is adjusted based on the thickness of the positive electrode sheet 21 that is wound around the winding shaft 110 acquired by the first process S31. Similarly, the control device 180 is configured to cause execution of a fourth process S34 in which the interval of the tabs 22d is adjusted based on the thickness of the negative electrode sheet 22 that is wound around the winding shaft 110 acquired by the second process S32. In this embodiment, the third calculator 189 of the control device 180 calculates a difference between the acquired thickness of each of the sheets and a reference thickness.

As used herein, the term “reference thickness” refers to a set value of a thickness of each sheet in forming the wound body 20a. A prepared sheet has variations in thickness in a surface thereof in some cases. For example, each of the positive electrode active material layer 21b and the negative electrode active material layer 22b can be formed by applying the active material in a slurry state to a base material (the positive electrode current collecting foil 21a and the negative electrode current collecting foil 22a) and drying it. Therefore, variations in thickness can occur in the positive electrode sheet 21 and the negative electrode sheet 22. The thicknesses of the positive electrode current collecting foil 21a, the negative electrode current collecting foil 22a, and the separators 31 and 32 are not necessarily constant. When there are variations in thickness of a sheet in a length direction thereof, a length of the sheet that is wound around the winding shaft 110 can vary. For example, when a sheet thickness is smaller than the reference thickness, an outer diameter of the wound body 20a wound around the winding shaft 110 is reduced. Thus, the positions of the tabs 21d and 22d can be shifted to positions that precede the predetermined positions described above. When the sheet thickness is larger than the reference thickness, the outer diameter of the wound body 20a wound around the winding shaft 110 is increased. Thus, the positions of the tabs 21d and 22d can be shifted to positions that follow the predetermined positions.

The third calculator 189 of the control device 180 can calculate shifts of the tabs 21d and 22d, based on the acquired difference between the thickness of each sheet and the reference thickness. The third adjustor 190 adjusts the processing conditions of the tabs 21d and 22d stored in the storage 181. For example, when the calculated sheet thickness is larger than the reference thickness, the processing conditions can be adjusted such that the tab pitch is increased. When the calculated sheet thickness is smaller than the reference thickness, the processing conditions can be adjusted such that the tab pitch is reduced.

The control device 180 is configured to cause execution of the first process S31 to the fourth process S34. Thus, in the control device 180, information of the thicknesses of the sheets before being wound are fed back and the processing conditions of the tabs are adjusted. For example, when a difference in tendency between the sheet thickness and the reference thickness is seen for each production lot, the processing conditions in winding the sheets in the same production lot can be adjusted. Thus, accuracy of a position of the wound body 20a after winding can be increased. As another option, the pitches of the tabs 21d and 22d in the sheets that are being wound may be adjusted in accordance with the thicknesses of the sheets. Thus, shifts of the positions of the tabs 21d and 22d due to variations in the thicknesses of the sheets can be reduced. As a result, also in the wound body 20a during winding, increased accuracy of the positions of the tabs 21d and 22d after winding can be achieved.

### Fourth Example

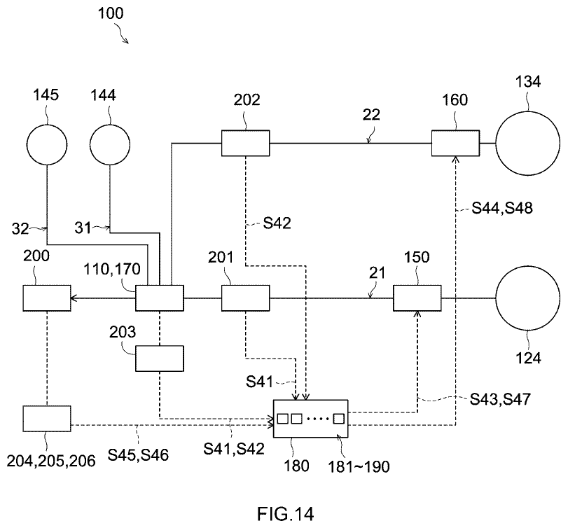

FIG. 14 is a block diagram illustrating a process that is executed by the control device 180 according to another embodiment. As illustrated in FIG. 14, similar to the first example, in the electricity storage device manufacturing apparatus 100, the first tab detection device 201, the second tab detection device 202, and the rotation angle measurement device 203 are provided. Furthermore, similar to the second example, in the electricity storage device manufacturing apparatus 100, the image inspection devices 204 to 206 are provided. The control device 180 is configured to cause execution of a first process S41 to an eighth process S48. Herein, the first process S41 to the fourth process S44 are similar to the first process S11 to the fourth process S14 of the first example, and the fifth process S45 to the eighth process S48 are similar to the first process S21 to the fourth process S24 of the second example.

In the electricity storage device manufacturing apparatus 100 described above, the rotation angle of the winding shaft 110 and the acquired tab pitch are fed back and the processing conditions of the tabs are adjusted by the first process S41 to the fourth process S44 that are executed by the control device 180. Furthermore, the positions of the tabs 21d and 22d of the wound body 20a after being pressed are fed back and the processing conditions of the tabs are adjusted by the fifth process S45 to the eighth process S48. Thus, in addition to an effect that the interval of the tabs can be easily made close to the set value, after winding, increased accuracy of the positions of the tabs 21d and 22d in the wound electrode body 20 after being pressed can be easily achieved. As a result, the accuracy of the positions of the tabs 21d and 22d can be further increased.

### Fifth Example

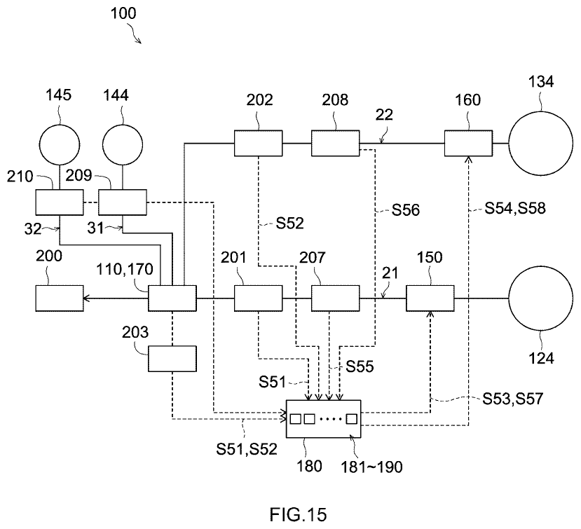

FIG. 15 is a block diagram illustrating a process that is executed by the control device 180 according to another embodiment. As illustrated in FIG. 15, similar to the first example, in the electricity storage device manufacturing apparatus 100, the first tab detection device 201, the second tab detection device 202, and the rotation angle measurement device 203 are provided. Furthermore, similar to the third example, in the electricity storage device manufacturing apparatus 100, the thickness inspection devices 207 to 210 are provided. The control device 180 is configured to cause execution of a first process S51 to an eighth process S58. Herein, the first process S51 to the fourth process S54 are similar to the first process S11 to the fourth process S14 of the first example, and the fifth process S55 to the eighth process S58 are similar to the first process S31 to the fourth process S34 of the third example.

In the electricity storage device manufacturing apparatus 100 described above, the rotation angle of the winding shaft 110 and the acquired tab pitch are fed back and the processing conditions of the tabs are adjusted by the first process S51 to the fourth process S54 that are executed by the control device 180. Furthermore, information of the thicknesses of the sheets before winding are fed back and the processing conditions of the tabs are adjusted by the fifth process S55 to the eighth process S58. Thus, in addition to the effect that the interval of the tabs can be easily made close to the set value, shifts of the positions of the tabs 21d and 22d due to variations in the thicknesses of the sheets can be reduced. As a result, the accuracy of the positions of the tabs 21d and 22d can be further increased.

### Sixth Example

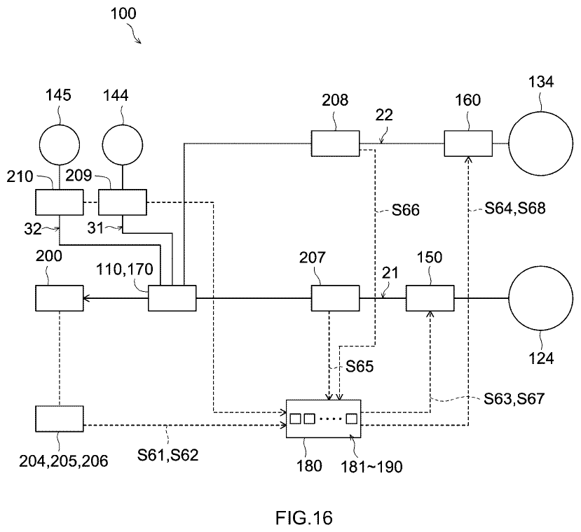

FIG. 16 is a block diagram illustrating a process that is executed by the control device 180 according to another embodiment. As illustrated in FIG. 16, similar to the second example, in the electricity storage device manufacturing apparatus 100, the image inspection devices 204 to 206 are provided. Furthermore, similar to the third example, in the electricity storage device manufacturing apparatus 100, the thickness inspection devices 207 to 210 are provided. The control device 180 is configured to cause execution of a first process S61 to an eighth process S68. Herein, the first process S61 to the fourth process S64 are similar to the first process S21 to the fourth process S24 of the second example, and the fifth process S65 to the eighth process S68 are similar to the first process S31 to the fourth process S34 of the third example.

In the electricity storage device manufacturing apparatus 100 described above, the positions of the tabs 21d and 22d of the wound body 20a after being pressed are fed back and the processing conditions of the tabs are adjusted by the first process S61 to the fourth process S64 that are executed by the control device 180. Furthermore, information of the thicknesses of the sheets before winding are fed back and the processing conditions of the tabs are adjusted by the fifth process S65 to the eighth process S68. Thus, in addition to an effect that shifts of the positions of the tabs 21d and 22d due to variations in the thicknesses of the sheets are reduced, after winding, increased accuracy of the positions of the tabs 21d and 22d in the wound electrode body 20 after being pressed can be easily achieved. As a result, the accuracy of the positions of the tabs 21d and 22d can be further increased.

### Seventh Example

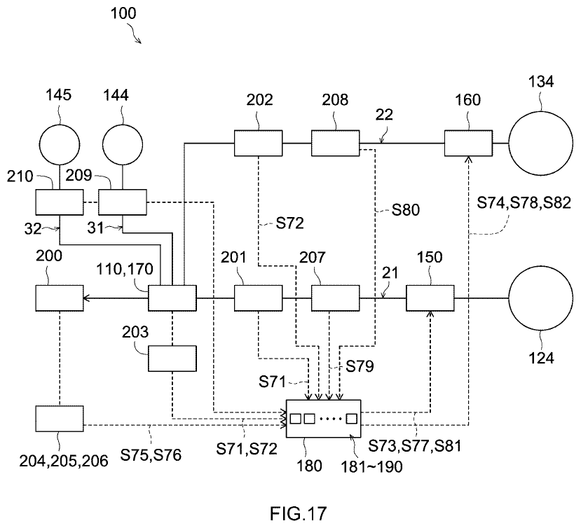

FIG. 17 is a block diagram illustrating a process that is executed by the control device 180 according to another embodiment. As illustrated in FIG. 17, similar to the first example, in the electricity storage device manufacturing apparatus 100, the first tab detection device 201, the second tab detection device 202, and the rotation angle measurement device 203 are provided. Furthermore, similar to the second example, in the electricity storage device manufacturing apparatus 100, the image inspection devices 204 to 206 are provided. Moreover, similar to the third example, in the electricity storage device manufacturing apparatus 100, the thickness inspection devices 207 to 210 are provided. The control device 180 is configured to cause execution of a first process S71 to a twelfth process S82. Herein, the first process S71 to the fourth process S74 are similar to the first process S11 to the fourth process S14 of the first example, the fifth process S75 to the eighth process S78 are similar to the first process S21 to the fourth process S24 of the second example, and the ninth process S79 to the twelfth process S82 are similar to the first process S31 to the fourth process S34 of the third example.

In the electricity storage device manufacturing apparatus 100 described above, the rotation angle of the winding shaft 110 and the acquired tab pitch are fed back and the processing conditions of the tabs are adjusted by the first process S71 to the fourth process S74 that are executed by the control device 180. Furthermore, the positions of the tabs 21d and 22d of the wound body 20a after being pressed are fed back and the processing conditions of the tabs are adjusted by the fifth process S75 to the eighth process S78. Moreover, information of the thicknesses of the sheets before winding are fed back and the processing conditions of the tabs are adjusted by the ninth process S79 to the twelfth process S82. Thus, in addition to the effect that the interval of the tabs can be easily made close to the set value, shifts of the positions of the tabs 21d and 22d due to variations in the thicknesses of the sheets can be reduced. Furthermore, after winding, increased accuracy of the positions of the tabs 21d and 22d in the wound electrode body 20 after being pressed can be easily achieved. As a result, the accuracy of the positions of the tabs 21d and 22d can be further increased.

In this embodiment, the processing conditions of the tabs are adjusted based on the tab pitches (variable 1) of the sheets 21 and 22 before winding acquired by the first and second processes S71 and S72, the positions of (variables 2 and 3) of the tabs 21d and 22d after pressing acquired by the fifth and sixth processes S75 and S76, and the thicknesses (variable 4) of the sheets 21, 22, 31, and 32 acquired by the ninth and tenth processes S79 and S80. Each of the tab pitches of the sheets 21 and 22 before winding, the positions of the tabs 21d and 22d after pressing, and the thicknesses of the sheets 21, 22, 31, and 32 may be weighted and reflected to the processing conditions of the tabs. Herein, each of the positions of the tabs 21d and 22d calculated from the image inspection devices 204 and 205 are the variable 2, and each of the positions of the tabs 21d and 22d calculated from the image inspection device 206 is the variable 3.

For example, weighting coefficients W1 to W4 may be allocated to the variables 1 to 4. The weighting coefficients W1 to W4 can be set such that a total of the weighting coefficients W1 to W4 is 1. A correction value of a tab pitch used for adjusting processing conditions of tabs can be expressed by an expression below:

$$Correction Value of Tab Pitch = W 1 \times Variable 1 + W 2 \times Variable 2 + W 3 \times Variable 3 + W 4 \times Variable 4$$

Note that the weighting coefficients W1 to W4 can be set as appropriate in accordance with a product specification, a processing condition, or the like. Therefore, the weighting coefficients W1 to W4 may be determined by data stored during production, testing, or the like.

Note that, from a viewpoint of stabilizing positions of tabs, tab processing is continuously performed on a sheet that is continuously conveyed at a constant speed. For example, a sheet on which no tab is formed can be conveyed from an unwinding roll to a winding roll and tabs can be formed on the sheet on a conveyance path. Thus, a roll around which the sheet with the tabs formed thereon is wound can be prepared. According to a trial conducted by the inventor of the present disclosure, when tab processing was stopped each time the wound body was formed, that is, when tab processing was performed during winding of a wound body or in like case, the positions of the tabs were shifted in some cases. However, according to the electricity storage device manufacturing apparatus 100 disclosed herein, each time the wound body 20a is formed, the positions of the tabs 21d and 22d or the like can be fed back to the processing conditions. The processing conditions of the tabs 21d and 22d are adjusted in accordance with the winding conditions of the wound body 20a during winding or the like. Thus, even when sheet conveyance and tab processing are intermittently operated, the accuracy of the positions of the tabs 21d and 22d can be easily increased.

The technology disclosed herein has been described above in various forms.

However, the embodiments described above shall not limit the present disclosure, unless specifically stated otherwise. An order of the first process to the twelfth process that are executed by the control device described above is not particularly limited, and may be changed as appropriate in accordance with steps of manufacturing an electricity storage device or the like. Various changes can be made to the technology described herein, and each of components and processes described herein can be omitted as appropriate or can be combined with another one or other ones of the components and the processes as appropriate, unless a particular problem occurs.

What is claimed is:

1. An electricity storage device manufacturing apparatus comprising:
a winding shaft;
a first conveyance device that conveys a band-like positive electrode sheet to the winding shaft;
a first laser tab cut processing device that forms tabs at intervals determined in advance on the positive electrode sheet that is conveyed by the first conveyance device;
a second conveyance device that conveys a band-like negative electrode sheet to the winding shaft;
a second laser tab cut processing device that forms tabs at intervals determined in advance on the negative electrode sheet that is conveyed by the second conveyance device;
a winding device that rotates the winding shaft and winds the positive electrode sheet on which the tabs are formed by the first laser tab cut processing device and the negative electrode sheet on which the tabs are formed by the second laser tab cut processing device; and
a control device,
wherein
the positive electrode sheet includes a band-like positive electrode current collecting foil and a positive electrode active material layer formed in an area excluding an unformed area set in a first edge portion in a width direction in the band-like positive electrode current collecting foil,
the negative electrode sheet includes a band-like negative electrode current collecting foil and a negative electrode active material layer formed in an area excluding an unformed area set in a first edge portion in a width direction in the band-like negative electrode current collecting foil,
the control device is configured to cause execution of
a first process in which a tab pitch of the positive electrode sheet that is wound around the winding shaft with respect to a rotation angle of the winding shaft is acquired,
a second process in which a tab pitch of the negative electrode sheet that is wound around the winding shaft with respect to the rotation angle of the winding shaft is acquired,
a third process in which the first laser tab cut processing device adjusts the intervals between the tabs that are formed on the positive electrode sheet, based on the tab pitch of the positive electrode sheet that is wound around the winding shaft with respect to the rotation angle of the winding shaft acquired by the first process, and
a fourth process in which the second laser tab cut processing device adjusts the intervals between the tabs that are formed on the negative electrode sheet, based on the tab pitch of the negative electrode sheet that is wound around the winding shaft with respect to the rotation angle of the winding shaft acquired by the second process.

2. The electricity storage device manufacturing apparatus according to claim 1, further comprising:
a pressing device that presses a wound body taken out from the winding shaft,
wherein
the control device is configured to further cause execution of
a fifth process in which positions of the tabs of the positive electrode sheet of the wound body after being pressed by the pressing device are acquired,
a sixth process in which positions of the tabs of the negative electrode sheet of the wound body after being pressed by the pressing device are acquired,
a seventh process in which the first laser tab cut processing device adjusts the intervals between the tabs that are formed on the positive electrode sheet, based on the positions of the tabs of the positive electrode sheet of the wound body after being pressed by the pressing device acquired by the fifth process, and
an eighth process in which the second laser tab cut processing device adjusts the intervals between the tabs that are formed on the negative electrode sheet, based on the positions of the tabs of the negative electrode sheet of the wound body after being pressed by the pressing device acquired by the sixth process.

3. The electricity storage device manufacturing apparatus according to claim 1, wherein
the control device is configured to further cause execution of:
a ninth process in which a thickness of the positive electrode sheet that is wound around the winding shaft is acquired,
a tenth process in which a thickness of the negative electrode sheet that is wound around the winding shaft is acquired,
an eleventh process in which the first laser tab cut processing device adjusts the intervals between the tabs that are formed in the unformed area of the positive electrode sheet, based on the thickness of the positive electrode sheet that is wound around the winding shaft with respect to the rotation angle of the winding shaft acquired by the ninth process, and
a twelfth process in which the second laser tab cut processing device adjusts the intervals between the tabs that are formed in the unformed area of the negative electrode sheet, based on the thickness of the negative electrode sheet that is wound around the winding shaft with respect to the rotation angle of the winding shaft acquired by the tenth process.

4. An electricity storage device manufacturing apparatus comprising:
a winding shaft;
a first conveyance device that conveys a band-like positive electrode sheet to the winding shaft;
a first laser tab cut processing device that forms tabs at intervals determined in advance on the positive electrode sheet that is conveyed by the first conveyance device;
a second conveyance device that conveys a band-like negative electrode sheet to the winding shaft;
a second laser tab cut processing device that forms tabs at intervals determined in advance on the negative electrode sheet that is conveyed by the second conveyance device;
a winding device that rotates the winding shaft and winds the positive electrode sheet on which the tabs are formed by the first laser tab cut processing device and the negative electrode sheet on which the tabs are formed by the second laser tab cut processing device;
a pressing device that presses a wound body taken out from the winding shaft; and
a control device,
wherein
the positive electrode sheet includes a band-like positive electrode current collecting foil and a positive electrode active material layer formed in an area excluding an unformed area set in a first edge portion in a width direction in the band-like positive electrode current collecting foil,
the negative electrode sheet includes a band-like negative electrode current collecting foil and a negative electrode active material layer formed in an area excluding an unformed area set in a first edge portion in a width direction in the band-like negative electrode current collecting foil,
the control device is configured to cause execution of
a first process in which positions of the tabs of the positive electrode sheet of the wound body after being pressed by the pressing device are acquired,
a second process in which positions of the tabs of the negative electrode sheet of the wound body after being pressed by the pressing device are acquired,
a third process in which the first laser tab cut processing device adjusts the intervals between the tabs that are formed on the positive electrode sheet, based on the positions of the tabs of the positive electrode sheet of the wound body after being pressed by the pressing device acquired by the first process, and
a fourth process in which the second laser tab cut processing device adjusts the intervals between the tabs that are formed on the negative electrode sheet, based on the positions of the tabs of the negative electrode sheet of the wound body after being pressed by the pressing device acquired by the second process.

5. The electricity storage device manufacturing apparatus according to claim 4, wherein
the control device is configured to further cause execution of
a fifth process in which a thickness of the positive electrode sheet that is wound around the winding shaft is acquired,
a sixth process in which a thickness of the negative electrode sheet that is wound around the winding shaft is acquired,
a seventh process in which the first laser tab cut processing device adjusts the intervals between the tabs that are formed in the unformed area of the positive electrode sheet, based on the thickness of the positive electrode sheet that is wound around the winding shaft with respect to the rotation angle of the winding shaft acquired by the fifth process, and
an eighth process in which the second laser tab cut processing device adjusts the intervals between the tabs that are formed in the unformed area of the negative electrode sheet, based on the thickness of the negative electrode sheet that is wound around the winding shaft with respect to the rotation angle of the winding shaft acquired by the sixth process.

6. An electricity storage device manufacturing apparatus comprising:
a winding shaft;
a first conveyance device that conveys a band-like positive electrode sheet to the winding shaft;
a first laser tab cut processing device that forms tabs at intervals determined in advance on the positive electrode sheet that is conveyed by the first conveyance device;
a second conveyance device that conveys a band-like negative electrode sheet to the winding shaft;
a second laser tab cut processing device that forms tabs at intervals determined in advance on the negative electrode sheet that is conveyed by the second conveyance device;
a winding device that rotates the winding shaft and winds the positive electrode sheet on which the tabs are formed by the first laser tab cut processing device and the negative electrode sheet on which the tabs are formed by the second laser tab cut processing device; and
a control device,
wherein
the positive electrode sheet includes a band-like positive electrode current collecting foil and a positive electrode active material layer formed in an area excluding an unformed area set in a first edge portion in a width direction in the band-like positive electrode current collecting foil,
the negative electrode sheet includes a band-like negative electrode current collecting foil and a negative electrode active material layer formed in an area excluding an unformed area set in a first edge portion in a width direction in the band-like negative electrode current collecting foil, and
the control device is configured to cause execution of
a first process in which a thickness of the positive electrode sheet that is wound around the winding shaft is acquired,
a second process in which a thickness of the negative electrode sheet that is wound around the winding shaft is acquired,
a third process in which the first laser tab cut processing device adjusts the intervals between the tabs that are formed in the unformed area of the positive electrode sheet, based on the thickness of the positive electrode sheet that is wound around the winding shaft with respect to the rotation angle of the winding shaft acquired by the first process, and
a fourth process in which the second laser tab cut processing device adjusts the intervals between the tabs that are formed in the unformed area of the negative electrode sheet, based on the thickness of the negative electrode sheet that is wound around the winding shaft with respect to the rotation angle of the winding shaft acquired by the second process.
